(19) United States
(12) Patent Application Publication
(10) Pub. No.: US 2021/0139116 A1
(43) Pub. Date: May 13, 2021

(54) MOVING BODIES AND MOVING BODY SYSTEM

(71) Applicant: HONDA MOTOR CO.,LTD., Tokyo (JP)

(72) Inventors: Hideharu OTAKE, Saitama (JP); Kei AMBO, Saitama (JP); Yuya TANAKA, Saitama (JP)

(21) Appl. No.: 17/155,083

(22) Filed: Jan. 22, 2021

Related U.S. Application Data
(63) Continuation of application No. PCT/JP2019/028920, filed on Jul. 23, 2019.

(30) Foreign Application Priority Data
Jul. 26, 2018 (JP) 2018-140172

(51) Int. Cl. B63B 79/40; B63B 34/56; G06T 7/73; G06K 9/00

(52) U.S. Cl. CPC B63B 79/40; B63B 34/56; G06T 2207/30204; G06K 9/00362; G06T 2207/30196; G06T 7/73

(57) ABSTRACT

A moving body that moves at least one of in water or along a water surface, in accordance with a person moving on the water by stepping with feet in an alternating manner, includes a movement information acquiring unit that acquires information concerning movement of a foot of the person or a worn item worn on the foot of the person, and a control unit that, when the foot of the person moves away from the moving body, causes the moving body to move to a stepping destination of the foot based on the information acquired by the movement information acquiring unit. A moving body system includes the moving body and the worn item.

### CROSS REFERENCE TO RELATED APPLICATION

The contents of the following Japanese patent application and internal application are incorporated herein by reference,
Japanese Patent Application No. 2018-140172 filed on Jul. 26, 2018 and
International Application No. PCT/JP2019/028920 filed on Jul. 23, 2019.

### BACKGROUND

### 1. Technical Field

The present invention relates to moving bodies and a moving body system.

### 2. Related Art

Equipment for walking on water is known (for example, see Patent Documents 1 to 3 below). Furthermore, an apparatus that moves on or in water is known (for example, see Patent Documents 4 and 5 below).

### PRIOR ART DOCUMENTS

### Patent Documents

Patent Document 1: Registered Utility Model No. 3118538
Patent Document 2: Japanese Patent Application Publication No. S48-36893
Patent Document 3: Japanese Patent No. 2991289
Patent Document 4: Japanese Patent Application Publication No. 2007-50490
Patent Document 5: Japanese Patent Application Publication No. 2000-247283

### BRIEF DESCRIPTION OF THE DRAWINGS

FIG. 1 schematically shows a usage environment of a moving body system 100 in a first embodiment.

FIG. 2 shows a state as seen from a direction orthogonal to the progression direction of the user 80 and the direction of gravity.

FIG. 3 schematically shows a state in which the moving body 10 is moving.

FIG. 4 schematically shows a vertical cross section of the moving body 10a.

FIG. 5 schematically shows a horizontal cross section of the moving body 10a.

FIG. 6 is a block diagram showing a functional configuration of the moving body 10.

FIG. 7 is a block diagram showing a functional configuration of the shoe 20.

FIG. 8 schematically shows an image 800 captured by the imaging apparatus 260 of the moving body 10.

FIG. 9 shows an example of change over time of the relative velocity of the moving body 10a with respect to the moving body 10b.

FIG. 10 schematically shows an example of change over time of the magnetic strength generated by the magnetism generating unit 250.

FIG. 11 schematically shows a situation where a moving body 10 proactively moves ahead to the stepping destination of a foot.

FIG. 12 shows an example of change over time of the relative velocity of the moving body 10a when control is performed to proactively move ahead to the stepping destination of the foot.

FIG. 13 schematically shows a method for acquiring the load received from the user 80 as the advance information.

FIG. 14 schematically shows another method for acquiring the load received from the user 80, as the advance information.

FIG. 15 schematically shows a situation of acquiring the stride length of the user 80 as the advance information.

FIG. 16 schematically shows a situation where energy management is performed by the moving body 10.

FIG. 17 schematically shows a situation where notification is provided when the remaining battery amount is insufficient.

FIG. 18 shows a state in which the floating body 290 of the moving body 10a has been deployed.

FIG. 19 schematically shows a situation where the charging and discharging are performed by the moving bodies 10 in the standby mode.

FIG. 20 schematically shows a situation where the moving bodies 10 move in the standby mode.

FIG. 21 schematically shows a situation where the user 80 is floating with the moving body 10a in the floating mode.

FIG. 22 shows the operational conditions of the moving mode, the standby mode, and the floating mode in a table format.

FIG. 23 is a diagram for describing a situation where control of attraction between the moving bodies 10 and the feet of the user 80 is performed.

FIG. 24 is a diagram for describing a situation where the control of attraction between the moving body 10 and the foot is prohibited.

FIG. 25 shows one form of a moving method of the moving body 10.

FIG. 26 shows one form of a movement method of the moving body 10b.

FIG. 27 schematically shows a state where charging and discharging are performed between the moving body 10a and the moving body 10b.

FIG. 28 schematically shows an arrangement example of moving bodies 10 included in a moving body system of a second embodiment.

FIG. 29 shows a state immediately after the shoe 20a has moved away from the moving body 10a.

FIG. 30 shows another arrangement example in the moving body system of the second embodiment.

FIG. 31 shows yet another arrangement example in the moving body system according to the second embodiment.

### DESCRIPTION OF EXEMPLARY EMBODIMENTS

Hereinafter, some embodiments of the present invention will be described, but the embodiments do not limit the invention according to the claims. Furthermore, all the combinations of the features described in the embodiments are not necessarily essential to means provided by aspects of the invention.

FIG. 1 schematically shows a usage environment of a moving body system 100 in a first embodiment. The moving body system 100 supports walking and running of a user 80 on water.

The moving body system 100 includes a moving body 10a, a moving body 10b, a shoe 20a, and a shoe 20b. In the description of the present embodiment, the moving body 10a and the moving body 10b may be referred to collectively as moving bodies 10. The shoe 20a and the shoe 20b may be referred to collectively as shoes 20. The user 80 is a person. The shoe 20a is footwear for the left foot of the user 80. The shoe 20b is footwear for the right foot of the user 80. The shoe 20a and the shoe 20b are examples of worn items that are worn on the feet of the user 80.

The moving bodies 10 move at least one of in the water or along the water surface, in accordance with the user 80 who moves on the water by stepping while alternating their feet. The moving body 10a and the moving body 10b each move individually at least one of in the water or along the water surface. In the present embodiment, the moving bodies 10 will be described as moving mainly through the water. In a case where the moving bodies 10 move through the water near the water surface, it is possible that portions of the moving bodies 10 will temporarily appear above the water surface, due to the effect of the movement of the water surface or the like. Furthermore, in a case where the moving bodies 10 move along the water surface, it is possible that the entirety of a moving body 10 will temporarily sink underwater, due to the effect of the movement of the water surface or the like. Obviously, the moving bodies 10 may move constantly within the water, or may move constantly along the water surface. The moving body 10a and the moving body 10b support different feet of the user 80. The moving body 10a supports the left foot of the user 80. The moving body 10b supports the right foot of the user 80.

FIGS. 2 and 3 schematically show situations in which the moving bodies 10 move. FIG. 2 shows a situation as seen from a direction orthogonal to the progression direction of the user 80 and the direction of gravity. FIG. 3 shows a situation as seen from a direction opposite the direction of gravity. In the following description, the direction orthogonal to the progression direction of the user 80 and the direction of gravity may be referred to as the “horizontal direction” or the like. Furthermore, the direction opposite the direction of gravity may be referred to as “upward” or the like.

The user 80 walks or runs by stepping with their feet in an alternating manner. The moving body 10a moves near the water surface according to the movement of the left foot of the user 80. The moving body 10a moves to a stepping destination 30a of the left foot of the user 80. The moving body 10b moves near the water surface according to the movement of the right foot of the user 80. The moving body 10b moves to a stepping destination 30b of the right foot of the user 80. As shown in FIG. 2, the moving body 10a moves through the water in a manner to track the movement of the shoe 20a, and the moving body 10b moves through the water in a manner to track the movement of the shoe 20b. The moving bodies 10 may predict the stepping destinations of the respective feet in the shoes 20, proactively move ahead to the predicted stepping destinations, and wait at the movement destination reached in advance for the foot of the user 80 to be placed thereon.

FIG. 4 schematically shows a vertical cross section of the moving body 10a. FIG. 5 schematically shows a lateral cross section of the moving body 10a.

The moving body 10a includes a first propulsion unit 11-1, a first propulsion unit 11-2, a first propulsion unit 11-3, and a first propulsion unit 11-4, as well as a second propulsion unit 12, that generate thrust for the moving body 10a. The first propulsion unit 11-1, the first propulsion unit 11-2, the first propulsion unit 11-3, and the first propulsion unit 11-4 may be referred to collectively as first propulsion units 11. The first propulsion units 11 apply a force in a direction orthogonal to the direction of gravity to the moving body 10a. For example, the first propulsion units 11 apply the force to the moving body 10a by ejecting water, which has been sucked in from around the moving body 10a, in a direction orthogonal to the direction of gravity. The first propulsion units 11 apply forces in different directions from each other to the moving body 10a. As an example, each first propulsion unit 11 may eject the water from a different position on a side portion 17 of the moving body 10a. By controlling the force applied to the moving body 10a by each first propulsion unit 11, it is possible to control the direction and velocity of the moving body 10a.

The second propulsion unit 12 applies a force in the direction opposite the direction of gravity to the moving body 10a. The second propulsion unit 12 is provided on a bottom surface 16 side of the moving body 10a. The second propulsion unit 12 applies the force in the direction opposite the direction of gravity to the moving body 10a by ejecting water, which has been sucked in from around the moving body 10a, in the direction of gravity. The second propulsion unit 12 may eject the water from the bottom surface 16, which is on the opposite side of the top surface 15 of the moving body 10a. The moving body 10a supports the load received from the user 80 by using a force in the upward direction provided by the second propulsion unit 12. The direction in which the second propulsion unit 12 ejects the water may be changeable. By controlling the direction in which the second propulsion unit 12 ejects the water, it is possible to achieve thrust in the direction of gravity even when the moving body 10a is in an inclined state.

The moving body 10a includes a charging pad 14-1, a charging pad 14-2, a charging pad 14-3, and a charging pad 14-4. The charging pad 14-1, the charging pad 14-2, the charging pad 14-3, and the charging pad 14-4 may be referred to collectively as charging pads 14. The charging pads 14 are used for charging and discharging between the moving body 10a and the moving body 10b. The charging and discharging through the charging pads 14 is performed using a non-contact technique. The charging and discharging using the charging pads 14 is described further below.

The moving body 10b has the same configuration as the moving body 10a. Therefore, a description concerning the specific configuration regarding propulsion of the moving body 10b is omitted.

According to the moving body system 100, it is possible for a user 80 to move on water in the same manner as walking on land, without wearing floating objects on the feet. Therefore, it is possible to walk and run freely on water.

FIG. 6 is a block diagram showing a functional configuration of a moving body 10. The moving body 10a and the moving body 10b have the same functional configuration. Therefore, these functional configurations are referred to in general here, and described as the functional configuration of the moving body 10. The moving body 10 includes an imaging apparatus 260, a processing unit 202, a storage unit 206, a sensor 208, a magnetism generating unit 250, the first propulsion units 11, the second propulsion unit 12, a communicating unit 204, a battery 280, the charging pads 14, and a floating body 290.

The battery 280 supplies the energy needed for each unit of the moving body 10 to operate. The battery 280 is charged by power supplied from the charging pads 14.

The communicating unit 204 handles communication with the shoes 20. The communicating unit 204 handles communication with the other moving body 10. The communicating unit 204 communicates with the shoes 20 and the other moving body 10 using radio waves or sound waves. Furthermore, the communicating unit 204 generates an alarm signal in the surrounding area.

The processing unit 202 includes a control unit 200, a detecting unit 230, a predicting unit 240, a movement information acquiring unit 210, and an advance information acquiring unit 270. The processing unit 202 is realized by a processor or the like. The storage unit 206 stores information for operating the communicating unit 204 and the processing unit 202. For example, the storage unit 206 stores programs for operating the processing unit 202 and the communicating unit 204. The storage unit 206 is realized by a storage medium such as a nonvolatile memory and a volatile memory. The functions of the moving body 10 are mostly realized by causing the processing unit 202 and the communicating unit 204 to operate based on the programs stored in the storage unit 206. In this way, each function of the moving body 10 is realized by a computer.

The sensor 208 includes a pressure sensor that detects the magnitude and direction of force acting on the top surface 15 of the moving body 10. Furthermore, the sensor 208 includes a position sensor that detects geographic position information of the moving body 10 based on GPS information or the like. The information detected by the sensor 208 is output to the processing unit 202.

The movement information acquiring unit 210 acquires information concerning the movement of the feet of the user 80 or of the shoes 20 worn on the feet of a person. When a foot of the user 80 is away from the moving body 10, the control unit 200 moves the moving body 10 to the stepping destination of the foot based on the information acquired by the movement information acquiring unit 210.

The movement information acquiring unit 210 receives the information indicating the movement of the feet of the user 80 or the shoes 20 from the shoes 20. The information indicating the movement of the feet of the user 80 or the shoes 20 may be referred to as “movement information”. Specifically, the movement information acquiring unit 210 receives the movement information from the shoes 20 via the communicating unit 204. The control unit 200 moves the moving body 10 to the movement destination of the foot predicted from the movement information.

For example, the position of the stepping destination of the foot is predicted by the predicting unit 240. As an example, the predicting unit 240 may predict the stepping destination of the foot based on information indicating the movement of the user 80 acquired from the shoes 20. The control unit 200 may move the moving body 10 to the position predicted by the predicting unit 240.

The movement information may be information indicating at least one of the movement acceleration of a foot, the movement direction of a foot, the movement velocity of a foot, the position of a foot, and the posture of a foot of the user 80, for example. The movement information acquiring unit 210 may acquire information detected by the pressure sensor included in the sensor 208, as the movement information.

The detecting unit 230 detects the position of the foot or shoe 20 of the user 80. The control unit 200 may move the moving body 10 in a manner to track the position of the foot or shoe 20 detected by the detecting unit 230.

As an example, the imaging apparatus 260 captures an image of the area above the moving body 10. The detecting unit 230 detects the position of the foot or shoe 20 from the image acquired by the imaging apparatus 260. The detecting unit 230 may detect the position of the foot or shoe 20 by detecting a predetermined mark attached to the foot or shoe 20. The detecting unit 230 may detect the position of the foot or shoe 20 by detecting the position of light having a predetermined wavelength emitted from the foot or shoe 20.

The detecting unit 230 may extract indicators that identify the right foot and left foot from the image. The control unit 200 may move the moving body 10 in a manner to track a predetermined foot set as the tracking target of the moving body 10, based on the indicators detected by the detecting unit 230.

The magnetism generating unit 250 generates magnetism that causes an attractive force with respect to the shoe 20. At least when the foot transitions from a swinging phase to a standing phase, the control unit 200 increases the strength of the magnetism generated by the magnetism generating unit 250. At least when the foot transitions from the standing phase to the swinging phase, the control unit 200 decreases the strength of the magnetism generated by the magnetism generating unit 250.

The first propulsion units 11 apply forces in a plurality of directions orthogonal to the direction of gravity to the moving body 10. The control unit 200 moves the moving body 10 to the stepping destination of the foot of the user 80 by controlling the force applied to the moving body 10 by each of the plurality of first propulsion units 11, based on the information acquired by the movement information acquiring unit 210. The control unit 200 may control the directions of the forces applied to the moving body 10 by the first propulsion units 11 by controlling the amount of water ejected by each first propulsion unit 11.

The second propulsion unit 12 applies a force in the direction opposite the direction of gravity to the moving body 10. The control unit 200 may control the force applied to the moving body 10 by the second propulsion unit 12 based on the load applied to the moving body 10 by the user 80. The control unit 200 may control the direction of the force applied to the moving body 10 by the second propulsion unit 12 by controlling the direction in which the second propulsion unit 12 ejects the water.

The sensor 208 includes an inclination sensor that detects inclination of the moving body 10 relative to the direction of gravity. The control unit 200 may control the force applied to the moving body 10 by the second propulsion unit 12, based on the inclination of the moving body 10 detected by the inclination sensor included in the sensor 208.

The advance information acquiring unit 270 acquires advance information concerning the user 80. The advance information includes information indicating the weight of the user 80, the stride length of the user 80, and the center of mass balance when the user 80 stands on the moving body 10. The control unit 200 controls the movement of the moving body 10 using the advance information.

The advance information acquiring unit 270 acquires at least one of the weight and the center of mass balance of the user 80, based on the force distribution in a state where the user 80 is standing still on the moving body 10. The advance information acquiring unit 270 may acquire the weight and center of mass balance of the user 80 based on a control quantity by which the control unit 200 controls the second propulsion unit 12 such that the moving body 10 is in a substantially still state.

The control unit 200 may instruct the user 80 standing on the moving body 10 to walk, and acquire the stride length of the user 80 based on the movement amount of the moving body 10 when the moving body 10 moves while tracking the walking of the user 80 who is walking according to the instruction.

The battery 280 accumulates the energy needed to move the moving body 10. The battery 280 accumulates electrical energy. The floating body 290 is deployed when the amount of energy accumulated in the battery 280 is less than a predetermined value.

The control unit 200 deploys the floating body 290 when a difference between the amount of energy accumulated in the battery 280 and the amount of energy needed to move the moving body 10 from the current position to a predetermined location for recovery of the moving body 10 becomes less than a predetermined value. The control unit 200 may prohibit the deployment of the floating body 290 if the distance to the predetermined location for recovery of the moving body 10 is shorter than a predetermined distance.

The following describes an operation concerning the operational modes of the moving body 10. The moving body 10 has a moving mode, a standby mode, and a floating mode as the operational modes. The moving mode is an operational mode in a case where the moving body 10 moves based on the movement of the foot of the user 80, as described above. The control unit 200 causes the moving body 10 to operate in the floating mode when a request is made by the user 80.

The detecting unit 230 detects the foot or shoe 20 of the user 80. If the foot or shoe 20 is detected within a predetermined range by the detecting unit 230, the control unit 200 causes the moving body 10 to move in the moving mode to move the moving body 10 to the stepping destination of the foot. If the foot or shoe 20 is not detected within the predetermined range by the detecting unit 230, the control unit 200 sets the moving body 10 to the standby mode. The predetermined range is a range on a side opposite the direction of gravity, with respect to the moving body 10.

In the standby mode, the control unit 200 may move the moving body 10 according to the movement of the shoe 20, such that the moving body 10 is positioned within a predetermined range from the shoe 20. In the standby mode, the control unit 200 may adjust the amount of accumulated energy between this moving body 10 and the other moving body 10 that supports the other foot.

If the moving body 10 has been moved to support one foot of the user 80 while in the moving mode before transitioning to the standby mode, when the transition is made from the standby mode to the moving mode, the control unit 200 may move the moving body 10 to support the other foot of the user 80. For example, there are cases where there is a large difference in the power consumption amount between the moving body 10 that supported the right foot and the moving body 10 that supported the left foot. For example, if the user 80 has walked with their center of mass oriented toward one foot, there may be a large difference in the power consumption amount. In such a case, it is possible to adjust the amount of power accumulated in the respective batteries 280 by switching the feet supported by the moving bodies 10 in the following moving mode.

The communicating unit 204 receives a biometric signal detected from the user 80, from the shoe 20. The control unit 200 sets the moving body 10 to the standby mode when the foot or shoe 20 is not detected within the predetermined range by the detecting unit 230 and the biometric signal received from the communicating unit 204 satisfies a predetermined condition. The control unit 200 causes the moving body 10 to operate in the floating mode if the foot or shoe 20 is not detected within the predetermined range by the detecting unit 230 and the biometric signal does not satisfy the predetermined condition. The control unit 200 causes the moving body 10 to operate in the floating mode if the foot or shoe 20 is not detected within the predetermined range by the detecting unit 230 and the distance from a predetermined location to the moving body 10 is greater than or equal to a predetermined distance.

In the floating mode, the control unit 200 may move the moving body 10 in a manner to support the body of the user 80 from below in the direction of gravity. The biometric signal may include at least one of a heart rate signal, a pulse signal, a breathing signal, a brain wave signal, and a voluntary movement signal.

The following describes an operation of controlling the magnetic force generated by the magnetism generating unit 250 according to the stepping destination of the foot. The control unit 200 causes the magnetism generating unit 250 to generate a force whose strength corresponds to the position of the stepping destination predicted by the predicting unit 240. The magnetism generating unit 250 generates magnetism that causes an attractive force with respect to the shoe 20. The magnetism generating unit 250 is an example of a force generating unit that generates an attractive force with respect to the shoe 20.

As an example, if the moving body 10 cannot be moved to the position predicted by the predicting unit 240, the control unit 200 causes the magnetism generating unit 250 to generate a stronger force when the foot transitions from the standing phase to the swinging phase than in a case where the moving body 10 can be moved to the position predicted by the predicting unit 240. Furthermore, if the water depth at the position predicted by the predicting unit 240 is less than a predetermined water depth in which the moving body 10 can be used, the control unit 200 causes the magnetism generating unit 250 to generate a stronger force when the foot transitions from the standing phase to the swinging phase than in a case where the water depth at the position predicted by the predicting unit 240 is greater than or equal to the predetermined water depth.

When the moving body 10 cannot be moved to the position predicted by the predicting unit 240, if there is a foothold for the user 80 at the position predicted by the predicting unit 240, the control unit 200 prohibits generation of the force by the magnetism generating unit 250 when the foot transitions from the standing phase to the swinging phase. This foothold may be land, or may be a structure such as a bridge.

When the foot transitions from the swinging phase to the standing phase, the control unit 200 may increase the force generated by the magnetism generating unit 250.

As described above, the advance information acquired by the advance information acquiring unit 270 includes information indicating the weight of the user 80. If the moving body 10 cannot be moved to the position predicted by the predicting unit 240, the control unit 200 may cause the magnetism generating unit 250 to generate the force, when the foot transitions from the standing phase to the swinging phase, to be stronger as the weight of the user 80 becomes greater. The advance information includes information indicating the stride length of the user 80. The predicting unit 240 may predict the stepping destination of the foot based on the stride length of the user 80.

The following describes an example of a movement situation in which the moving body 10 moves. When the first foot of the user 80 is separated from the moving body 10, the control unit 200 may move the moving body 10 to the stepping destination of a first foot along the side portion of the other moving body 10 that supports a second foot of the user 80, while rotating the moving body 10 in a plane parallel to the movement direction of the moving body 10. If the first foot is the left foot of the user 80 who is advancing, the control unit 200 may move the moving body 10 to the stepping destination of the first foot while rotating the moving body 10 clockwise, and if the first foot is the right foot of the user 80 who is advancing, the control unit 200 may move the moving body 10 to the stepping destination of the first foot while rotating the moving body 10 counterclockwise. The moving body 10 preferably has a substantially cylindrical shape.

The control unit 200 may move the moving body 10 to the stepping destination of the first foot while rotating the moving body 10 in a state where the side portion of the moving body 10 is in contact with the side portion of the other moving body 10. The control unit 200 may transfer electric energy between the moving body 10 and the other moving body 10, through the side portion of the moving body 10 and the side portion of the other moving body 10.

FIG. 7 is a block diagram showing a functional configuration of a shoe 20. The shoe 20a and the shoe 20b have the same functional configuration. Therefore, these functional configurations are referred to in general here, and described as the functional configuration of the shoe 20. The shoe 20 includes a sensor 300, a processing unit 302, a communicating unit 304, a storage unit 306, a notifying unit 330, a battery 380, and a magnet 350.

The battery 380 supplies the energy needed for the operation of the storage unit 306, the processing unit 302, the communicating unit 304, the notifying unit 330, and the sensor 300. An attractive force is generated between the magnet 350 and the magnetism generating unit 250 by the magnetic force generated from the magnet 350 and the magnetic force generated by the magnetism generating unit 250 of the moving body 10. Magnets 350 are provided separately at a heel side and a toe side of the shoe 20.

The processing unit 302 is realized by a processor or the like. The storage unit 306 stores information for operating the communicating unit 304 and the processing unit 302. The storage unit 306 stores programs for operating the processing unit 302 and the communicating unit 304. The storage unit 306 is realized by a storage medium such as a nonvolatile memory and a volatile memory. The functions of the shoe 20 are mostly realized by causing the processing unit 302 and the communicating unit 304 to operate based on the programs stored in the storage unit 306. In this way, each function of the shoe 20 is realized by a computer.

The communicating unit 304 handles communication with the moving body 10. The communicating unit 304 transmits sensor information, which includes the information detected by the sensor 300, to the moving body 10.

The sensor 300 includes an acceleration sensor. The information detected by this acceleration sensor is used by the moving body 10 to calculate the movement acceleration, the movement velocity, and the position of the foot of the user 80. Therefore, the information detected by the acceleration sensor is an example of information indicating the movement acceleration, movement velocity, and position of the foot of the user 80. The sensor 300 may include a plurality of acceleration sensors. The information detected by this plurality of acceleration sensors is used by the moving body 10 to calculate the posture of the foot of the user 80. Accordingly, the information detected by the plurality of acceleration sensors is an example of information indicating the posture of the foot of the user 80. The sensor 300 includes a biometric sensor that detects biometric information. At least one of a heart rate signal, a pulse signal, and a voluntary movement signal is included as the biometric information.

A plurality of sensors may be provided at a plurality of locations on the body of the user 80. The information acquired by this plurality of sensors may be transmitted to the shoe 20, and transmitted to the moving body 10 via the communicating unit 304. For example, acceleration sensors may be provided at a plurality of locations on the body of the user 80. The information detected by these acceleration sensors is used to calculate the posture of the user 80. Furthermore, biometric sensors may be provided at a plurality of locations on the body of the user 80. The information detected by these biometric sensors can be exemplified by a breathing signal, a brain wave signal, and the like.

The notifying unit 330 notifies the user 80 about information. For example, the notifying unit 330 notifies the user 80 about the information by generating a vibration with a predetermined pattern according to the information about which the user 80 is to be notified.

The shoe 20 of the present embodiment is an example of a worn item that is worn on the foot of the user 80. The worn item may be any object other than the shoe 20. For example, the worn item may be a ring or the like worn on the foot of the user 80.

FIG. 8 schematically shows an image 800 captured by the imaging apparatus 260 of the moving body 10. The image 800 is used to detect the position of the foot of the user 80.

In the moving body 10a, the detecting unit 230 detects the position of the shoe 20a by detecting an image 810 of the shoe 20a, using image recognition, within the image 800 captured by the imaging apparatus 260. The position of the shoe 20a detected from the image changes in accordance with the movement of the foot. In the moving body 10a, the control unit 200 controls the first propulsion units 11 to move the moving body 10a such that the center of mass position of the shoe 20a detected from the image is contained in a predetermined range 820 in the image.

Marks for detecting the feet of the user 80 are provided on the bottom surfaces of the shoe 20a and the shoe 20b. The detecting unit 230 may detect the positions and orientations of the feet by detecting these marks, from the image 800. For example, the detecting unit 230 of the moving body 10a may detect the positions and orientations of the feet by detecting, from the image 800, the positions and orientations of the image 830 and the image 840 of the predetermined marks.

The mark formed on the shoe 20a may have a predetermined shape indicating that this is the left foot. The mark formed on the shoe 20b may have a predetermined shape indicating that this is the right foot. Furthermore, the mark formed on the shoe 20a may be formed by a substance that emits light of a predetermined color indicating that this is the left foot. The mark formed on the shoe 20b may be formed by a substance that emits light of a predetermined color indicating that this is the right foot. The mark formed on the shoe 20a may be formed of a substance that emits light of a predetermined wavelength indicating that this is the left foot. The mark formed on the shoe 20b may be formed of a substance that emits light of a predetermined wavelength indicating that this is the right foot.

In this way, each of the moving body 10a and the moving body 10b can detect the position of the foot that is the tracking target of this moving body 10, by detecting an image of a mark from the image 800 with the detecting unit 230.

The detecting unit 230 may detect the position of the foot based on the acceleration information included in the sensor information transmitted from the shoe 20. The detecting unit 230 may detect the position of the foot based on this acceleration information and the image 800.

FIG. 9 shows an example of change over time of the relative velocity of the moving body 10a with respect to the moving body 10b. At the timing t1, the left foot of the user 80 is at the end of the standing phase, and the right foot of the user 80 is at a stage of having transitioned from the swinging phase to the standing phase. At the timing t2, the left foot of the user 80 is in the swinging phase, and the right foot of the user 80 is in the standing phase. At the timing t3, the left foot of the user 80 is at stage of having transitioned from the swinging phase to the standing phase, and the right foot of the user 80 is in the standing phase.

If both feet of the user 80 are in the standing phase, the control units 200 of the respective moving body 10a and moving body 10b each control the velocity of the corresponding moving body 10 in a manner to maintain a predetermined positional relationship between the moving body 10a and the moving body 10b.

If the moving body 10a is being moved to track the movement of the left foot, when the left foot of the user 80 transitions from the standing phase to the swinging phase after the timing t1, the control unit 200 of the moving body 10a moves the moving body 10a in a manner to track the left foot of the user 80. At the timing t3, when the left foot of the user 80 transitions from the swinging phase to the standing phase, the control unit 200 of the moving body 10a controls the velocity of the moving body 10a in a manner to maintain a predetermined positional relationship between the moving body 10a and the moving body 10b. The control unit 200 of the moving body 10b causes the moving body 10b to track the movement of the right foot, by performing the same type of control as the control unit 200 of the moving body 10a.

If the foot has been detected from the image captured by the imaging apparatus 260, the control unit 200 may judge whether the foot of the user 80 has transitioned from the standing phase to the swinging phase. Furthermore, the control unit 200 may judge whether the foot of the user 80 has transitioned from the standing phase to the swinging phase based on the magnitude of the pressure detected by the sensor 208.

FIG. 10 schematically shows an example of change over time of the magnetic strength generated by the magnetism generating unit 250. The timings t1 to t3 refer to the same timings as the timings t1 to t3 described in relation to FIG. 9. At the timing t4, the left foot of the user 80 is in the standing phase, and the right foot of the user 80 is at a stage of having transitioned from the standing phase to the swinging phase. The timing t4 is a timing at which the left foot of the user 80 is in the middle of the standing phase.

In the moving body 10a, before the left foot of the user 80 transitions from the swinging phase to the standing phase, the control unit 200 increases the magnetic strength generated by the magnetism generating unit 250. By increasing the magnetic strength generated by the magnetism generating unit 250, the attractive force between the magnet 350 of the shoe 20a and the magnetism generating unit 250 is increased. Due to this, the moving body 10a and the shoe 20a can be adhered to each other.

In the moving body 10a, the control unit 200 lowers the magnetic force generated by the magnetism generating unit 250 during the interval from the timing t3 to the timing t4. The control unit 200 lowers the magnetic strength generated by the magnetism generating unit 250 to substantially zero, at least until before the left foot transitions from the standing phase to the swinging phase.

FIG. 11 schematically shows a situation where a moving body 10 proactively moves ahead to the stepping destination of a foot. In the moving body 10a, the predicting unit 240 predicts the stepping destination of the left foot of the user 80. For example, the predicting unit 240 predicts the stepping destination of the left foot of the user 80 based on the direction in which the user 80 is currently walking, the direction of the pressure detected by the sensor 208 of the moving body 10a, and the stride length of the user 80. The control unit 200 of the moving body 10a moves the moving body 10a quickly to the stepping destination of the left foot of the user 80 predicted by the predicting unit 240, by controlling the first propulsion units 11.

Similarly, the predicting unit 240 in the moving body 10b predicts the stepping destination of the right foot of the user 80. For example, the predicting unit 240 of the moving body 10b predicts the stepping destination of the right foot of the user 80 based on the direction in which the user 80 is currently walking, the direction of the pressure detected by the sensor 208 of the moving body 10b, and the stride length of the user 80. The control unit 200 of the moving body 10b moves the moving body 10b quickly to the stepping destination of the right foot of the user 80 predicted by the predicting unit 240, by controlling the first propulsion units 11 of the moving body 10b. By repeating the operations described above, the moving body 10a and the moving body 10b support the feet of the user 80 stepping in an alternating manner.

FIG. 12 shows an example of change over time of the relative velocity of the moving body 10a when control is performed to proactively move ahead to the stepping destination of the foot. The timings t1 to t3 refer to the same timings as the timings t1 to t3 described in relation to FIG. 9. Here, the description focuses on points differing from those in the control described in relation to FIG. 9.

When the left foot of the user 80 transitions from the standing phase to the swinging phase after the timing t1, the control unit 200 of the moving body 10a moves the moving body 10a to the stepping destination of the left foot predicted by the predicting unit 240. As shown in FIG. 12, at the timing t2, the moving body 10a is positioned farther forward in the progression direction than the left foot of the user 80. After the moving body 10a has arrived at the stepping destination predicted by the moving body 10a, the control unit 200 of the moving body 10a finely adjusts the position of the moving body 10a based on the acceleration information of the left foot included in the sensor information transmitted from the shoe 20a and the position information of the left foot detected from the image captured by the imaging apparatus 260, until the left foot reaches the moving body 10a. Then, at the timing t3, when the left foot of the user 80 transitions from the swinging phase to the standing phase, the control unit 200 of the moving body 10a controls the velocity of the moving body 10a in a manner to maintain the predetermined positional relationship between the moving body 10a and the moving body 10b. The control unit 200 of the moving body 10b proactively moves the moving body 10b ahead to the stepping destination of the right foot by performing the same type of control as the control unit 200 of the moving body 10a.

FIG. 13 schematically shows a method for acquiring the load received from the user 80 as the advance information. Before the user 80 using the moving body 10a and the moving body 10b starts walking, the moving body 10a and the moving body 10b instruct the user 80 to adopt a standing posture with the left foot and right foot of the user 80 on the moving body 10a and the moving body 10b. For example, the processing units 302 of the shoe 20a and the shoe 20b cause the notifying units 330 to generate vibrations having patterns corresponding to instructions for adopting a standing posture.

The control units 200 of the moving body 10a and the moving body 10b control the respective second propulsion units 12 of the moving body 10a and the moving body 10b in a manner to balance the load of the user 80 and the thrust generated by the second propulsion units 12 of the moving body 10a and the moving body 10b. In the moving body 10a and the moving body 10b, the advance information acquiring units 270 calculate the thrust to be generated by the second propulsion units 12 of the moving body 10a and the moving body 10b, based on the control information of the second propulsion units 12. The advance information acquiring units 270 calculate the load applied to the moving body 10a and the moving body 10b based on the calculated thrusts and the buoyancies of the moving body 10a and the moving body 10b. This load includes the bodyweight of the user 80 and the weight of objects born by the user 80.

Furthermore, the control units 200 of the moving body 10a and the moving body 10b calculate the center of mass position of the user 80 based on the thrust of the second propulsion unit 12 of the moving body 10a and the thrust of the second propulsion unit 12 of the moving body 10b. In this way, it is possible to acquire in advance which of the left foot and the right foot is applying a load. Accordingly, it is possible to acquire in advance the standing habit of the user 80, for example. Furthermore, it is possible to acquire in advance an imbalance of the weight of objects born by the user 80. The control unit 200 may use the center of mass position, which is acquired as advance information, as a correction value when predicting the movement direction of the user 80.

In the moving body 10a and the moving body 10b, the control units 200 calculate the thrusts to be output by the second propulsion units 12 when a foot of the user 80 transitions to the standing phase and when a foot of the user 80 is in the standing phase, using the load information acquired by the advance information acquiring units 270. In this way, it is possible to prevent significant sinking of the moving bodies 10 when the feet of the user 80 are on the moving bodies 10 and to prevent the moving bodies 10 from significantly jumping out above the water surface. The control units 200 may adjust the magnitude of the force resisting the force applied to the moving bodies 10 by kicking of the feet, by adjusting the thrusts of the second propulsion units 12.

In this way, by acquiring the load received from the user 80 as advance information before use, it is possible to acquire the weight, including worn items, carried objects, and the like, and the center of mass position of the user 80. Due to this, it is possible to acquire more accurate information than in the case of a method where the weight and the like of the user 80 are registered as advance information.

FIG. 14 schematically shows another method for acquiring the load received from the user 80, as the advance information. The load acquiring method shown in FIG. 14 differs from the method shown in FIG. 13 in that the user 80 stands on one foot. The moving body 10a instructs the user 80 to adopt a posture of standing on the moving body 10a with only their left foot. For example, the processing unit 302 of the shoe 20a causes the notifying unit 330 to generate a vibration with a pattern corresponding to the instructions for adopting a posture of standing on the left foot.

The control unit 200 of the moving body 10a controls the second propulsion unit 12 of the moving body 10a in a manner to balance the load of the user 80 and the thrust generated by the second propulsion unit 12 of the moving body 10a. In the moving body 10a, the advance information acquiring unit 270 calculates the thrust generated by the second propulsion unit 12 of the moving body 10a, based on the control information of the second propulsion unit 12. The advance information acquiring unit 270 calculates the load applied to the moving body 10a based on the calculated thrust and the buoyancy of the moving body 10a. The control unit 200 of the moving body 10a transmits, to the moving body 10b, information indicating the load acquired by the advance information acquiring unit 270. In this way, it is possible to share load information between the moving body 10a and the moving body 10b.

FIG. 15 schematically shows a situation of acquiring the stride length of the user 80 as the advance information. From the state shown in FIG. 13, the user 80 is instructed to start walking slowly. For example, the processing units 302 of the shoe 20a and the shoe 20b cause the notifying units 330 to generate vibrations having patterns corresponding to walking start instructions. In this case, the vibration may be generated by only the notifying unit 330 of the shoe 20 worn on the foot that starts walking.

If walking starts with the right foot, the control unit 200 of the moving body 10b causes the moving body 10b to track the movement of the right foot. The advance information acquiring unit 270 of the moving body 10b acquires the stride length L of the user 80 based on a position of the moving body 10b at which the right foot was removed from the moving body 10b and a position of the moving body 10b at which the right foot was placed on the moving body 10b. The control unit 200 of the moving body 10b transmits, to the moving body 10a, information indicating the stride length acquired by the advance information acquiring unit 270. In this way, stride length information can be shared between the moving body 10a and the moving body 10b

The stride length information acquired by the advance information acquiring unit 270 is used by the predicting unit 240 to predict the stepping destination of the foot.

FIG. 16 schematically shows a situation where energy management is performed by the moving body 10. In FIG. 16, the user 80 starts walking using the moving bodies 10 with a bridge 1600 as the origin. The bridge 1600 is an example of a recovery location where the moving bodies 10 are recovered.

In each of the moving body 10a and the moving body 10b, the control unit 200 stores the SOC of the battery 280 when the walking starts. After the walking using the moving bodies 10 has started, the control unit 200 consecutively acquires the current SOC of the battery 280. The control unit 200 calculates the consumed power amount from when the walking started to the current time, based on the SOC when the walking started and the current SOC.

The control unit 200 calculates a required power amount needed to walk to the bridge 1600 or the shore 1610 using the moving body 10, based on a distance D1 from the current position detected by the sensor 208 to the bridge 1600 or a distance D2 from the current position to the shore 1610. If a difference between the current accumulated power amount of the battery 280 calculated from the current SOC and the required power amount is less than a predetermined first power amount, the control unit 200 notifies the user 80 that the remaining battery amount is low. For example, the control unit 200 notifies the user 80 by causing the notifying unit 330 of one of the shoe 20a and the shoe 20b to vibrate with a predetermined pattern.

FIG. 17 schematically shows a situation where notification is provided when the remaining battery amount is insufficient. In each of the moving body 10a and the moving body 10b, the control unit 200 calculates the required power amount needed to walk to the bridge 1600 or the shore 1610 using the moving body 10, based on a distance D3 from the current position of the moving body 10 to the bridge 1600 and a distance D4 from the current position to the shore 1610. If the current accumulated power amount of the battery 280 calculated from the current SOC is less than the required power amount, the control unit 200 notifies the user 80 that the remaining battery amount is insufficient. For example, the control unit 200 notifies the user 80 by causing the notifying unit 330 of one of the shoe 20a and the shoe 20b to vibrate with a predetermined pattern indicating insufficient power. Furthermore, the control unit 200 deploys the floating body 290 after notifying the user 80 about the insufficient power.

FIG. 18 shows a state in which the floating body 290 of the moving body 10a has been deployed. The control unit 200 deploys the floating body 290 when the accumulated power amount of the battery 280 has become less than the required power amount. The floating body 290 may be deployed using a similar method as used when deploying an airbag, for example.

When the floating body 290 is deployed, the floating body 290 swells into a boat shape. The floating body 290 includes a convex portion 292 capable of housing the user 80, in the deployed state. When the floating body 290 is in the deployed state, the floating body 290 and the moving body 10 can be maneuvered by the thrust realized by the first propulsion units 11.

FIG. 19 schematically shows a situation where the charging and discharging are performed by the moving bodies 10 in the standby mode. The moving body 10 has the moving mode and the standby mode, as operational modes. The moving mode is an operational mode for moving to the stepping destinations of the feet that step in an alternating manner, as described above. The moving body 10 esters a standby state in the standby mode when the user 80 gets off the moving body 10 to rest on the water surface or start diving in the water, for example.

As an example, when the feet of the user 80 have not been detected above the moving bodies 10 for at least a predetermined time, the moving body 10a and the moving body 10b transition to the standby mode. For example, when the detecting unit 230 has been unable to detect the foot from the image captured by the imaging apparatus 260 for at least a predetermined time, the moving body 10a transmits a non-detection signal indicating that the foot cannot be detected to the moving body 10b. Similarly, when the detecting unit 230 has been unable to detect the foot of the user 80 for at least the predetermined time, the moving body 10b transmits a non-detection signal to the moving body 10a.

The moving body 10a transitions to the standby mode if a non-detection signal has been transmitted to the moving body 10b and a non-detection signal has been received from the moving body 10b. Similarly, the moving body 10b transitions to the standby mode if a non-detection signal has been transmitted to the moving body 10a and a non-detection signal has been received from the moving body 10a.

When the control units 200 of the moving body 10a and the moving body 10b have detected that both moving bodies 10 have entered the standby mode, the control units 200 charge and discharge the power of the batteries 280 between the moving bodies 10. For example, if the accumulated power amount of the battery 280 of the moving body 10a is less than the accumulated power amount of the battery 280 of the moving body 10b, the control unit 200 of the moving body 10a acquires power from the moving body 10b to charge the battery 280 of the moving body 10a. If the accumulated power amount of the battery 280 of the moving body 10b is less than the accumulated power amount of the battery 280 of the moving body 10a, the control unit 200 of the moving body 10b acquires power from the moving body 10a to charge the battery 280 of the moving body 10b.

The charging and discharging of power between the moving body 10a and the moving body 10b is performed through charging pads 14 that face each other. The control units 200 of the moving body 10a and the moving body 10b communicate with each other to adjust the positions and orientations of the moving bodies 10 such that the charging pads 14 are positioned close to each other and face each other. FIG. 19 shows a state in which the charging pad 14-4 of the moving body 10a and the charging pad 14-2 of the moving body 10b are facing each other. The control units 200 of the moving body 10a and the moving body 10b compare the accumulated power amounts of the respective batteries 280, and determine which of the battery 280 of the moving body 10a and the battery 280 of the moving body 10b is to be charged. When one of the batteries 280 is determined to be a charging target, charging of power from the other battery 280 to this one battery 280 is started. The charging and discharging of power between the moving body 10a and the moving body 10b ends when the difference between the accumulated power amounts of the batteries 280 of the respective moving bodies 10 is less than a predetermined value.

FIG. 20 schematically shows a situation where the moving bodies 10 move in the standby mode. The control units 200 of the moving body 10a and the moving body 10b extract position information of the respective shoes 20 from the signals transmitted from each of the shoe 20a and the shoe 20b. The control units 200 move the moving bodies 10 toward the positions indicated by the position information of the shoes 20. In this way, even when the user 80 gets off the moving bodies 10 and starts diving in the water, the moving bodies 10 move in a manner to track the user 80. Therefore, when the user 80 stops diving and floats up, the moving bodies 10 are near the position where the user 80 floats up. Due to this, it is possible to prevent the user 80 from losing sight of the moving bodies 10. Furthermore, it is possible to eliminate the effort of having the user 80 search for the moving bodies 10.

The moving body system 100 may further include a remote controller 90 for remotely controlling the moving bodies 10 from the water. The user 80 may dive in the water while holding or wearing the remote controller 90. If the user 80 is in the water, the remote controller 90 may emit a signal indicating the position information of the remote controller 90. The control units 200 of the moving body 10a and the moving body 10b may extract the position information of the remote controller 90 from the signal transmitted from the remote controller 90, and cause the moving bodies 10 to move toward the position indicated by the position information. The remote controller 90 may include a button 92 that receives a float request from the user 80. The operation performed when a float request is received from the user 80 is described in relation to FIG. 21.

FIG. 21 schematically shows a situation where the user 80 is floating with the moving body 10a in the floating mode. The moving body 10 has a floating mode for causing the user 80 to float on the water, in addition to the moving mode and the standby mode, as an operational mode. If the user 80 is in the water and makes a request to float on the water, the moving body 10 causes the user 80 to float. For example, when the user 80 presses the button 92 of the remote controller 90, the remote controller 90 emits a float request signal. Upon receiving the float request signal from the remote controller 90, the moving body 10 transitions from the standby mode to the floating mode. As an example, in the floating mode, the control unit 200 of the moving body 10a causes the user 80 to float on the water by moving the moving body 10a below the user 80 and controlling to the second propulsion unit 12 such that the body of the user 80 is supported from below by the moving body 10a.

The moving body 10 may transition to the floating mode if the user 80 is in the water and a biometric signal satisfying a predetermined condition can no longer be obtained. If the shoe 20a and the shoe 20b are detected below the water surface, the control unit 200 of the moving body 10a acquires a biometric signal from the signal transmitted from the shoe 20a or the shoe 20b. The control unit 200 then judges whether the biometric signal satisfying the predetermined condition is obtained. For example, the control unit 200 may judge whether the number of pulse beats per minute is greater than a predetermined value. The control unit 200 may judge whether the number of heart beats per minute is greater than a predetermined value. The control unit 200 may judge whether the number of breaths taken per minute is greater than a predetermined value.

If it is judged that the biometric signal satisfying the predetermined condition is not obtained, the control unit 200 may operate in the floating mode. In this case, the control unit 200 may emit an alarm signal from the communicating unit 204 to the surrounding area.

In the floating mode, the moving body 10a may move while supporting the body of the user 80 in a state where the moving body 10a is grasped by an arm of the user 80. Furthermore, in the floating mode, the moving body 10a may move while supporting the treading of water by the user 80. Yet further, the moving body 10a and the moving body 10b may cooperate to move in a state of supporting the user 80.

FIG. 22 shows the operational conditions of the moving mode, the standby mode, and the floating mode in a table format. If the foot of the user 80 is detected above the moving body 10, the control unit 200 causes operation in the moving mode.

If the foot of the user 80 is not detected above the moving body 10 and the user 80 is positioned near the water surface, the control unit 200 causes the moving body 10 to operate in the standby mode. A judgment concerning whether the user 80 is positioned near the water surface may be made based on the position of the emission source of a sound wave signal emitted from a shoe 20. When operating in the standby mode, if the biometric signal emitted from the shoe 20 does not satisfy the predetermined condition, the control unit 200 causes the alarm signal to be emitted to the surrounding area.

In a case where the foot of the user 80 is not detected above the moving body 10 and the user 80 is positioned in the water, if the biometric signal satisfying the predetermined condition is detected, the moving body 10 is caused to operate in the standby mode.

The following is a description of what happens, in a case where the foot of the user 80 is not detected above the moving body 10 and the user 80 is positioned in the water, if the biometric signal satisfying the predetermined condition is not detected. If the distance from the current position of the moving body 10 to the shore is less than a predetermined distance, the control unit 200 causes the moving body 10 to operate in the standby mode and to emit an alarm signal to the surrounding area. If the distance from the current position of the moving body 10 to the shore is greater than or equal to the predetermined distance, the control unit 200 may cause the moving body 10 to operate in the floating mode and emit the alarm signal to the surrounding area.

FIG. 23 is a diagram for describing a situation where control of attraction between the moving bodies 10 and the feet of the user 80 is performed. FIG. 23 shows a stage where the left foot is in the standing phase and the right foot has transitioned from the swinging phase to the standing phase. The left foot of the user 80 is at a stage of entering the end of the standing phase.

The predicting unit 240 of the moving body 10a predicts the position 2310 of the stepping destination of the left foot. The control unit 200 judges whether the moving body 10a can move to the predicted position 2310. For example, if there is a rock formation 2300 at the prediction position 2310, the control unit 200 judges that the moving body 10a cannot be moved there. Furthermore, if the water depth of the predicted position 2310 is less than a predetermined water depth needed for movement of the moving body 10a, the control unit 200 judges that the moving body 10a cannot move to the predicted position 2310.

Information indicating the positions of rock formations and water depth is stored in the storage unit 206. The control unit 200 references the information stored in the storage unit 206 to judge whether the moving body 10a can move to a certain position.

If the moving body 10a cannot be moved to the predicted position 2310, the control unit 200 increases the magnetic strength generated by the magnetism generating unit 250. By increasing the magnetic strength generated by the magnetism generating unit 250, the attractive force between the magnet 350 provided in the shoe 20 and the magnetism generating unit 250 is increased. Due to this, it becomes more difficult for the shoe 20 to move away from the moving body 10a, and therefore the user 80 notices that they cannot advance in the progression direction.

The control unit 200 may determine the magnitude of the magnetic strength generated by the magnetism generating unit 250, according to the load of the user 80 acquired as the advance information. For example, the magnetic strength generated by the magnetism generating unit 250 may be increased as the load of the user 80 becomes larger. In general, it is predicted that users 80 with greater weight will have greater leg strength. Therefore, by making the magnetic strength greater when the load of the user 80 acquired as the advance information is greater, it is possible to avoid having the shoe 20 easily move away from the moving body 10a, even when the leg strength of the user 80 is high.

The magnetic strength generated by the magnetism generating unit 250 positioned on the heel side and the magnetic strength generated by the magnetism generating unit 250 positioned on the toe side may be controlled individually. For example, the control unit 200 may increase the magnetic strength of the magnetism generating unit 250 positioned on the toe side after increasing the magnetic strength generated by the magnetism generating unit 250 positioned on the heel side,

In this way, after the heel side of the shoe 20a has moved away from the moving body 10a, it becomes difficult for the toe side of the shoe 20a to move away from the moving body 10a, thereby making it easy to notice that advancement in the progression direction is not possible.

FIG. 24 is a diagram for describing a situation where the control of attraction between the moving body 10 and the foot is prohibited. As shown in FIG. 24, there is a bridge 2400 at the predicted position 2410 of the stepping destination of the left foot of the user 80. The moving body 10a cannot move to the predicted position 2410, but the user 80 can walk on the bridge 2400. In such a case, the control unit 200 prohibits the magnetism generating unit 250 from generating magnetism.

In this way, even in a case where the moving body 10 cannot move to the predicted position 2410, if the predicted position 2410 is a location that is effective as a foothold, the control unit 200 prohibits the magnetism generating unit 250 from generating magnetism.

FIG. 25 shows one form of a moving method of the moving body 10. In FIG. 25, the positions of the moving body 10a and the moving body 10b at a stage where the left foot of the user 80 transitions from the standing phase to the swinging phase are shown by solid lines. The movement control of the moving body 10a is described with reference to FIG. 25.

When the left foot transitions to the swinging phase, the moving body 10a starts moving to the position 2504 of the stepping destination of the left foot. In this case, the control unit 200 of the moving body 10a first causes the moving body 10a to move in a straight line toward the stepping destination position 2504. When the moving body 10a contacts the moving body 10b (position 2501), the control unit 200 controls the first propulsion units 11 such that the moving body 10a rotates clockwise, as seen from above. Due to this, the moving body 10a moves through the position 2502 to the position 2503, while rotating along the side portion of the moving body 10b. The control unit 200 then causes the moving body 10a to move in a straight line from the position 2503 to the position 2504.

FIG. 26 shows one form of a movement method of the moving body 10b. The movement of the moving body 10b after the moving body 10a has moved to the position 2504 in FIG. 25 is described with reference to FIG. 26. In FIG. 26, the positions of the moving body 10a and the moving body 10b at a stage where the right foot of the user 80 transitions from the standing phase to the swinging phase are shown by solid lines.

When the right foot transitions to the swinging phase, the moving body 10b starts moving toward the position 2604 of the stepping destination of the right foot. In this case, the control unit 200 of the moving body 10b first causes the moving body 10b to move in a straight line toward the stepping destination position 2604. When the moving body 10b contacts the moving body 10a (position 2601), the control unit 200 controls the first propulsion units 11 such that the moving body 10b rotates counter-clockwise, as seen from above. Due to this, the moving body 10b moves through the position 2602 to the position 2603, while rotating along the side portion of the moving body 10a. The control unit 200 then causes the moving body 10b to move in a straight line from the position 2603 to the position 2604.

By repeating the movement forms described in relation to FIGS. 25 and 26 in an alternating manner, the moving body 10a and the moving body 10b move to the stepping destinations of the feet of the user 80. In this way, the moving bodies 10 can move to the stepping destinations of the feet along the shortest distance in the horizontal plane, and can reduce the water resistance received when moving. The moving body 10a and the moving body 10b of the present embodiment are individual moving bodies. In another form, the moving body 10a and the moving body 10b may be joined at peripheral portions to be able to rotate relative to each other.

FIG. 27 schematically shows a state where charging and discharging are performed between the moving body 10a and the moving body 10b. FIG. 27 shows a state where the moving body 10a moves while rotating along the side portion of the moving body 10b.

As shown in FIG. 27, the charging pad 14-1 of the moving body 10a is in a state of being close to the charging pad 14-1 of the moving body 10b. The control unit 200 of the moving body 10a and the control unit 200 of the moving body 10b perform the charging and discharging between the battery 280 of the moving body 10a and the battery 280 of the moving body 10b, via the charging pad 14-1 of the moving body 10a and the charging pad 14-1 of the moving body 10b. For example, if the accumulated power amount of the battery 280 of the moving body 10a is less than the accumulated power amount of the battery 280 of the moving body 10b, charging from the battery 280 of the moving body 10b to the battery 280 of the moving body 10a is performed via the charging pads 14-1 of the moving body 10a and the moving body 10b.

In this way, the moving body 10a and the moving body 10b can perform charging and discharging therebetween while moving relative to each other. Therefore, it is possible to restrict the occurrence of a difference in accumulated power amounts between the moving bodies 10 while the user 80 walks using the moving bodies 10.

FIG. 28 schematically shows an arrangement example of moving bodies 10 included in a moving body system of a second embodiment. FIG. 28 shows a state of the arrangement of the moving bodies 10 at a certain timing, as seen from above.

The moving body system of the second embodiment includes the moving body 10a, the moving body 10b, and a moving body 10c as the moving bodies. The moving body 10c has the same functional configuration as the moving body 10a and the moving body 10b. The moving body system of the second embodiment differs from the moving body system 100 of the first embodiment with regard to the content of the movement control of the moving bodies 10. Accordingly, the following description focuses on this difference, and descriptions of other points are omitted.

In FIG. 28, the left foot of the user 80 is at a stage of transitioning from the standing phase to the swinging phase. The right foot of the user 80 is in the standing phase. At this timing, the moving body 10c is at a predicted position 2801 of the stepping destination of the left foot. In this way, the moving body 10c waits one step ahead of the left foot.

FIG. 29 shows a state immediately after the shoe 20a has moved away from the moving body 10a. When the shoe 20a is away from the moving body 10a and the left foot transitions to the swinging phase, the control unit 200 of the moving body 10a moves the moving body 10a toward the predicted position 2802 of the next stepping destination of the right foot of the user 80. For example, the control unit 200 of the moving body 10a moves the moving body 10a to the predicted position 2802 along a route 2850 that bypasses the moving body 10b in the horizontal plane. The control unit 200 of the moving body 10a may move the moving body 10a to the predicted position 2802 along the route 2860 passing below the moving body 10b.

According to the moving body system of the second embodiment, at a timing when both feet of the user 80 are in the standing phase, the moving body 10c is at the predicted position of the next step. Therefore, when the rotation of a foot of the user 80 happens quickly, it is possible to restrict the possibility of the movement of the moving bodies 10 not being performed in time. Furthermore, since the moving bodies 10 respectively support the right foot and the left foot in an alternating manner, there are cases where it is possible to restrict an increase of the difference in the consumed power amounts among the moving bodies 10.

FIG. 30 shows another arrangement example of moving bodies 10 in the moving body system of the second embodiment. In the same manner as in FIG. 28, in FIG. 30, the left foot of the user 80 is at a stage of transitioning from the standing phase to the swinging phase, and the right foot of the user 80 is in the standing phase. At this timing, the moving body 10c is at a predetermined position relative to the moving body 10a. Specifically, the moving body 10c is at a position 3001 where it is predicted that the left foot will be placed when the user 80 loses their posture in a state where the left foot is in the swinging phase. In this way, it is possible to reduce the possibility of the user 80 falling down.

After the state shown in FIG. 30, if it is predicted that the left foot of the user will move to the predicted position of the stepping destination without the user 80 losing their posture, the moving body 10c may move from the position 3001 to the predicted position of the stepping destination of the left foot. As another control method, after the left foot of the user 80 has transitioned from the standing phase to the swinging phase, the moving body 10c may remain at the position 3001 and the moving body 10a may move to the predicted position of the stepping destination of the left foot.

FIG. 31 shows yet another arrangement example of the moving bodies 10 in the moving body system according to the second embodiment. In the same manner as in FIG. 30, in FIG. 31, the left foot of the user 80 is at a stage of transitioning from the standing phase to the swinging phase, and the right foot of the user 80 is in the standing phase. At this timing, the moving body 10c is at a predetermined position relative to the moving body 10b. Specifically, the moving body 10c is at a position 3101 where it is predicted that the right foot will be placed when the user 80 loses their posture backward and to the right from the state shown in FIG. 31. In this way, it is possible to reduce the possibility of the user 80 falling down.

The arrangement of the moving body 10c is not limited to the arrangement examples described in relation to FIGS. 29 to 31. For example, the moving body 10c may track the moving body 10a and the moving body 10b while maintaining a predetermined space therebetween. Then, when the accumulated power amount of the battery 280 of the moving body 10a becomes less than the accumulated power amount of the battery 280 of the moving body 10c, the moving body 10c may be controlled, instead of the moving body 10a, to move to the stepping destination of the left foot of the user 80. When the moving body 10a is replaced with the moving body 10c, the moving body 10c waits at the predicted position of the left foot that is one step ahead, as described in relation to FIG. 28. Then, after the left foot of the user 80 has been placed on the moving body 10c, the moving body 10c may be controlled to move to the stepping destination of the left foot of the user 80.

In this way, by using the moving body 10c, it is possible to switch the roles of the moving bodies 10 without having the user 80 stop walking. After switching roles with the moving body 10c, the moving body 10a may move away from the moving body 10b and the moving body 10c and return to the recovery location of the moving body 10a. The recovery location may be the bridge 1600 or the like described in relation to FIG. 16 and the like. Furthermore, after switching with the moving body 10c, the moving body 10a may follow the moving body 10b and the moving body 10c. Then, when the accumulated power amount of the battery 280 of the moving body 10b becomes less than the accumulated power amount of the battery 280 of the moving body 10a, the moving body 10a, instead of the moving body 10b, may be controlled to move to the stepping destination of the right foot of the user 80.

When the difference between the accumulated power amount of the battery 280 of the moving body 10a and the accumulated power amount of the battery 280 of the moving body 10b becomes greater than a predetermined value, the moving body 10a and the moving body 10b may switch roles, to switch to control by which the moving body 10a moves to the stepping destination of the right foot and the moving body 10b moves to the stepping destination of the left foot. In this way, it is possible to adjust the accumulated power amounts between the moving body 10a and the moving body 10b. In this case as well, when the moving body 10a and the moving body 10b switch roles, the moving body 10c can be used temporarily. For example, after the moving body 10a has moved to the stepping destination of the right foot as described in relation to FIG. 29, the control is switched to control for moving the moving body 10a to the stepping destination of the right foot of the user 80. Then, in the state shown in FIG. 29, when the right foot of the user 80 moves away from the moving body 10b, the moving body 10b, after having moved to the stepping destination of the left foot, switches to control to move to the stepping destinations of the left foot of the user 80.

As described in relation to FIGS. 28 to 31, the moving body system of the second embodiment includes three or more moving bodies 10 that move through the water to support the feet of the user 80. At least two moving bodies 10 among the three or more moving bodies 10 move to the stepping destinations of the feet based on information concerning the movement of the feet of the user 80. Then, when the moving body 10a among the three or more moving bodies 10 is at the position of a first foot of the user 80 and the moving body 10b among the three or more moving bodies 10 is at the position of a second foot of the user 80, the third moving body 10 among the three or more moving bodies 10 stays at a position where it is possible to move to a stepping destination of whichever foot among the first foot and the second foot of the user 80 is to step next.

Specifically, when the first foot transitions from the standing phase to the swinging phase, the moving body 10c waits at the predicted position of the stepping destination of the first foot. Then, the moving body 10a, the moving body 10b, and the moving body 10c move in a manner to support the feet transitioning from the swinging phase to the standing phase, in a predetermined order.

Furthermore, as described in relation to FIGS. 30 and 31, the predetermined position may be a position where it is predicted that a foot of the user will be placed when the user 80 loses their posture. When it is sensed that the user 80 has lost their posture, the moving body 10c may move the position where the foot is placed when the user 80 loses their posture.

When the moving body 10a is operating to move to the stepping destination of the first foot and the moving body 10b is operating to move to the stepping destination of the second foot, the moving body 10c moves in a manner to stay at a predetermined position relative to the position of the user 80, in order to switch roles with one of the moving body 10a and the moving body 10b when a predetermined condition is satisfied. For example, when the energy accumulated in the battery 280 of the moving body 10a becomes less than a predetermined value, the moving body 10c starts an operation to move to the stepping destination of the first foot, in place of the moving body 10a. In a case where the moving body 10a is moving in a manner to maintain a predetermined position, when energy amount accumulated in the battery 280 of the moving body 10b becomes less than a predetermined value, the moving body 10a may start moving to support the second foot, in place of the moving body 10b.

After the moving body 10c has switched with the moving body 10a and started moving to support the first foot, the moving body 10a may return to the predetermined recovery location for recovering the moving body 10a. Furthermore, after the moving body 10c has switched with the moving body 10a and started operating to move to the stepping destination of the first foot, the moving body 10a may move in a manner to stay at the predetermined position described above, on a condition that the energy amount accumulated in the battery 280 of the moving body 10a is greater than a predetermined energy amount needed to return to the recovery location. Then, the moving body 10a may start returning to the recovery location according the result of a comparison between the energy amount accumulated in the battery 280 of the moving body 10a and the energy amount needed to return to the recovery location. For example, the moving body 10a may start returning to the recovery location if the difference between the energy amount accumulated in the battery 280 of the moving body 10a and the energy amount needed to return to the recovery location is less than a predetermined value.

The moving body 10a, the moving body 10b, and the moving body 10c adjust the energy amounts accumulated in the respective batteries 280, among the plurality of batteries included respectively therein. For example, the moving body 10a, the moving body 10b, and the moving body 10c each have a first moving mode for moving to support a foot in the standing phase and a second moving mode for moving without supporting a foot in the standing phase. By causing the moving body 10 having the lowest energy amount among the moving body 10a, the moving body 10b, and the moving body 10c to operate in the second moving mode, the energy amounts among the plurality of batteries are adjusted. For example, in the situation described in relation to FIGS. 30 and 31, the moving modes of the moving body 10a and the moving body 10b correspond to the first moving mode, and the moving mode of the moving body 10c corresponds to the second moving mode.

In a period during which the moving body 10a is controlled to move to the stepping destination of the first foot and the moving body 10b is controlled to move to the stepping destination of the second foot, if the difference between the energy amount accumulated in the battery 280 of the moving body 10a and the energy amount accumulated in the battery 280 of the moving body 10b has changed by at least a predetermined value, adjustment of the energy amounts between the moving body 10a and the moving body 10b is performed by switching roles such that the moving body 10a moves to the stepping destination of the second foot and the moving body 10b moves to the stepping destination of the first foot. In this case, when role switching between the moving body 10a and the moving body 10b is performed, the moving body 10c temporarily moves to the stepping destination of the foot transitioning from the swinging phase to the standing phase, in place of one of the moving body 10a and the moving body 10b. In this way, it is possible to adjust the energy amounts of the batteries 280, without having the user 80 stop walking.

As described in relation to the operation of acquiring the advance information with the moving body system 100 of the first embodiment, the moving body 10a and the moving body 10b acquire the advance information concerning the user 80 based on the control information of the first propulsion units 11 and the second propulsion units 12 for supporting the feet of the user 80. On the other hand, the moving body 10c may acquire the advance information concerning the user 80 from at least one of the moving body 10a and the moving body 10b.

According to the moving body system described above, the user 80 can freely walk or run on water, without wearing large floating devices for walking on water on their feet. In the moving body system described above, the shoes 20 can be omitted. The moving body system described above can be applied to locations where there is at least a water surface, such as the ocean, a lake, or a pool, or may be applied to locations where there is a liquid surface created by another stored liquid.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10. moving body
11. first propulsion unit
12. second propulsion unit
14. charging pad
15. top surface
16. bottom surface
17. side portion
20. shoe
30. stepping destination
80. user
90. remote controller
92. button
100. moving body system
200. control unit
202. processing unit
204. communicating unit
206. storage unit
208. sensor
210. movement information acquiring unit
230. detecting unit
240. predicting unit
250. magnetism generating unit
260. imaging apparatus
270. advance information acquiring unit
280. battery
290. floating body
292. concave portion
300. sensor
302. processing unit
304. communicating unit
306. storage unit
330. notifying unit
350. magnet
380. battery
800. image
810. image
820. range
830, 840. image
1600. bridge
1610. shore
2300. rock formation
2310. position
2400. bridge
2410. predicted position
2501, 2502, 2503, 2504. position
2601, 2602, 2603, 2604. position
2801, 2802. predicted position
2850, 2860. route
3001, 3101. position

What is claimed is:

1. A moving body for moving at least one of in water or along a water surface, in accordance with a person moving on the water by stepping with feet in an alternating manner, the moving body comprising:
a movement information acquiring unit for acquiring information concerning movement of a foot of the person or a worn item worn on the foot of the person; and
a control unit for, when the foot of the person is away from the moving body, causing the moving body to move to a stepping destination of the foot based on the information acquired by the movement information acquiring unit.

2. The moving body according to claim 1, wherein
the movement information acquiring unit is configured to receive information indicating the movement from the worn item, and
the control unit is configured to cause the moving body to move to a movement destination of the foot predicted from the information indicating the movement.

3. The moving body according to claim 2, wherein
the information indicating the movement of the person includes information indicating at least one of movement acceleration of the foot, a movement direction of the foot, movement velocity of the foot, a position of the foot, and a posture of the foot.

4. The moving body according to claim 1, further comprising:
a detecting unit for detecting a position of the foot of the person or the worn item, wherein
the control unit is configured to move the moving body in a manner to track the position of the foot or the worn item detected by the detecting unit.

5. The moving body according to claim 4, further comprising:
an imaging apparatus, wherein
the detecting unit is configured to detect positions of the foot, the worn item, a predetermined mark provided on the foot or the worn item, and light having a predetermined wavelength emitted from the foot or the worn item, from an image acquired by the imaging apparatus.

6. The moving body according to claim 5, wherein
the detecting unit is configured to extract an indicator identifying a left foot and a right foot from the image, and
the control unit is configured to move the moving body in a manner to track a predetermined foot set as a tracking target of the moving body, based on the indicator detected by the detecting unit.

7. The moving body according to claim 1, further comprising:
a magnetism generating unit for generating magnetism causing an attractive force with respect to the worn item.

8. The moving body according to claim 7, wherein
at least when the foot transitions from a swinging phase to a standing phase, the control unit is configured to increase strength of the magnetism generated by the magnetism generating unit.

9. The moving body according to claim 7, wherein
at least when the foot transitions from a standing phase to a swinging phase, the control unit is configured to decrease strength of the magnetism generated by the magnetism generating unit.

10. The moving body according to claim 1, further comprising:
a plurality of first propulsion units that are configured to apply forces, in a plurality of directions orthogonal to a direction of gravity, to the moving body, wherein
the control unit is configured to move the moving body to a stepping destination of the foot by controlling the force applied to the moving body by each of the plurality of first propulsion units, based on the information acquired by the movement information acquiring unit.

11. The moving body according to claim 1, further comprising:
a second propulsion unit for applying a force, in a direction opposite to a direction of gravity, to the moving body, wherein
the control unit is configured to control the force applied to the moving body by the second propulsion unit based on a load applied to the moving body from the person.

12. The moving body according to claim 11, comprising:
an inclination detecting unit for detecting inclination of the moving body relative to the direction of gravity, wherein
the control unit is configured to control the second propulsion unit based on the inclination.

13. The moving body according to claim 1, comprising:
an advance information acquiring unit for acquiring advance information concerning the person, wherein
the control unit is configured to control movement of the moving body using the advance information.

14. The moving body according to claim 13, wherein
the advance information includes information indicating weight of the person, stride length of the person, and balance of a center of mass when the person is standing on the moving body.

15. The moving body according to claim 14, wherein
the advance information acquiring unit is configured to acquire at least one of the weight of the person and the balance of the center of mass, based on a distribution of force in a state where the person is standing still on the moving body.

16. The moving body according to claim 14, wherein
the control unit is configured to instruct the person standing on the moving body to walk, and acquire the stride length of the person based on a movement amount of the moving body when the moving body moves to track the walking of the person who is walking according to the instruction.

17. The moving body according to claim 1, further comprising:
a battery that is configured to accumulate energy needed for the moving body to move; and
a floating body that is configured to be deployed when an energy amount accumulated in the battery is lower than a predetermined value.

18. The moving body according to claim 17, wherein
the control unit is configured to deploy the floating body when a difference between the energy amount accumulated in the battery and an energy amount needed for the moving body to move from a current position of the moving body to a predetermined location for recovery of the moving body becomes less than a predetermined value.

19. The moving body according to claim 17, wherein
the control unit is configured to prohibit deployment of the floating body if a distance to a predetermined location for recovery of the moving body is shorter than a predetermined distance.

20. A moving body system comprising:
a plurality of the moving bodies according to claim 1, wherein
at least one moving body among the plurality of moving bodies is configured to move to a stepping destination of a first foot of the person, and
at least one other moving body among the moving bodies is configured to move to a stepping destination of a second foot of the person.

21. A moving body system comprising:
the moving body according to claim 1; and
the worn item.
